(19) United States
(12) Patent Application Publication
(10) Pub. No.: US 2004/0242739 A1
(43) Pub. Date: Dec. 2, 2004

(54) Use of fluoroalkane sulfonic acids for stabilising organic plastics containing halogen

(76) Inventors: Peter Daute, Beverstedt (DE); Joerg-Dieter Klamann, Alderley (AU); Dieter Marks, Loxstedt (DE)

Correspondence Address: COGNIS CORPORATION, PATENT DEPARTMENT, 300 BROOKSIDE AVENUE, AMBLER, PA, 19002, US

(21) Appl. No.: 10/481,673

(22) PCT Filed: Jun. 21, 2002
(86) PCT No.: PCT/EP02/06887

(30) Foreign Application Priority Data
Jun. 30, 2001 (DE) 101 31 764.6

(51) Int. Cl. C08L 1/00

(52) U.S. Cl. 524/157

(57) ABSTRACT

Methods of stabilizing halogen-containing organic plastics are described, wherein the methods comprise: (a) providing a fluoroalkanesulfonic acid; and (b) combining the fluoroalkanesulfonic acid and the halogen-containing organic plastic. Stabilizer compositions containing a fluoroalkanesulfonic acid and PVC containing such stabilizers are also described.

### FIELD OF THE INVENTION

This invention relates to the use of fluoroalkanesulfonic acids for stabilizing halogen-containing organic plastics.

### PRIOR ART

It is known that halogen-containing plastics or molding compositions produced from them tend to undergo degradation or decomposition reactions on exposure to heat stress or on contact with high-energy radiation, for example ultraviolet light.

The stabilizing of PVC during processing has generally involved the use of metal-containing stabilizers based on Pb, Ba, Cd, Sn, Ca and Zn. As long ago as 1940, urea derivatives, such as diphenylthiourea for example, were proposed for stabilizing PVC (cf. Gächter/Müller, “Kunststoff-Additive”, Carl Hanser Verlag 1989, p. 312). These compounds are generally used in combination with metal-containing stabilizers because the long-term stability they provide on their own is generally inadequate.

### DESCRIPTION OF THE INVENTION

The problem addressed by the present invention was to provide substances which would be suitable for stabilizing halogen-containing organic plastics, more particularly PVC, against thermal and/or photochemical degradation.

The present invention relates to the use of fluoroalkanesulfonic acids for stabilizing halogen-containing organic plastics against thermal and/or photochemical degradation.

Fluoroalkanesulfonic acids in the context of the present invention are understood to be organic sulfonic acids which contain at least one fluorine atom per molecule. The fluoroalkanesulfonic acids to be used in accordance with the invention have one sulfonic acid group per molecule. Other preferred fluoroalkanesulfonic acids contain 1 to 18 carbon atoms per molecule. Completely fluorinated alkanesulfonic acids containing 1 to 18 carbon atoms per molecule are most particularly preferred. The fluoroalkanesulfonic acids may be used as such or in the form of their salts, preferably alkali metal salts. Accordingly, the expression “fluoroalkanesulfonic acids” in the context of the invention encompasses both the fluoroalkanesulfonic acids as such and their salts.

Examples of suitable fluoroalkanesulfonic acids are trifluoromethanesulfonic acid, perfluoroethanesulfonic acid, perfluorooctanesulfonic acid.

The fluoroalkanesulfonic acids and their salts may be used individually or in admixture with one another. A most particularly preferred embodiment is characterized by the use of trifluoromethanesulfonic acid or its salts.

The fluoroalkanesulfonic acids are preferably used in the form of their salts, more particularly their alkali metal salts. Of these, the lithium, sodium and potassium salts are preferred.

The fluoroalkanesulfonic acids are used to stabilize halogen-containing organic plastics, more especially PVC, in a quantity of 0.001 to 2 phr and more particularly 0.01 to 0.5 phr. The expression “parts per hundred resin (phr)” indicates how many parts by weight of the component are present in the plastic, based on 100 parts by weight of plastic.

The present invention relates to stabilizer compositions for stabilizing halogen-containing organic plastics against thermal and/or photochemical degradation, characterized in that the compositions contain one or more fluoroalkanesulfonic acids. Particulars of the nature of the fluoroalkanesulfonic acids and preferred variants thereof can be found in the foregoing.

In one embodiment, the stabilizer compositions according to the invention additionally contain one or more plastic additives selected from the group consisting of

(d1) cyanoacetyl ureas,

(d2) aminouracils,

(d3) perchlorates,

(d4) zeolites,

(d5) cationic layer compounds,

(d6) CHAP compounds,

(d7) katoites,

(d8) glycidyl compounds,

(d9) β-diketones and β-ketoesters,

(d10) dihydropyridines and polydihydropyridines,

(d11) polyols and disaccharide alcohols,

(d12) sterically hindered amines (tetraalkyl piperidine compounds),

(d13) alkali metal alumocarbonates (dawsonites),

(d14) alkali metal and alkaline earth metal compounds,

(d15) antioxidants,

(d16) parting agents and/or slip agents,

(d17) plasticizers,

(d18) pigments,

(d19) fillers,

(d20) phosphites,

(d21) thiophosphites and thiophosphates,

(d22) mercaptocarboxylic acid esters,

(d23) epoxidized fatty acid esters,

(d24) UV absorbers and photostabilizers,

(d25) blowing agents,

(d26) urea,

(d27) metal soaps,

(d28) antistatic agents.

The compounds of classes (d1) to (d28) are well-known to the expert as additives for halogen-containing plastics, more particularly PVC. Representative examples of substances belonging to these classes can be found, for example, in EP-A-768 336 which was cited at the beginning.

In connection with the use of the term “additive” for the compounds of classes (d1) to (d28), it is pointed out that the expert on the processing of plastics classifies additives both from structural and from functional perspectives.

In the case of functional classification, typical additives are antistatic agents, antifogging agents, antioxidants, UV stabilizers, coupling agents, calendering aids, mold release agents, slip agents, parting agents, lubricants, plasticizers, fragrances, flame retardants, fillers, pigments, blowing agents, agents for increasing thermal stability (heat stabilizers).

The above-mentioned additive classes (d1) to (d28) largely follow the structural classification, i.e. the classification in regard to chemical structure. With some classes, however, the functional definition was preferred.

It is also pointed out that compounds belonging to a certain class, i.e. compounds which can be structurally assigned to the same class, often perform not just one function, but two or more functions in practice. For example, calcium soaps can act as slip agents and/or parting agents, but may also be used to improve thermal stability, for example in the processing of polyvinyl chloride (PVC).

Compounds of Groups d1) to d28)

The compounds d1) are cyanoacetylureas. These are substances known to the expert which correspond to formula (D-1):

NC—CH₂—CO—N(R¹)—CO—NH—R² (D-1)

in which R¹ and R² independently of one another represent an unbranched or branched, linear or cyclic alkyl group containing 1 to 18 carbon atoms or an aryl group containing 6 to 18 carbon atoms which may optionally be substituted by one or more alkyl groups each containing 1 to 6 carbon atoms. N,N′-dimethyl-N-cyanoacetylurea is particularly preferred for the purposes of the invention. In the case of this compound, the substituents R¹ and R² in formula (D-1) are each a methyl group.

The compounds d2) are aminouracils which correspond to formula (D-2):

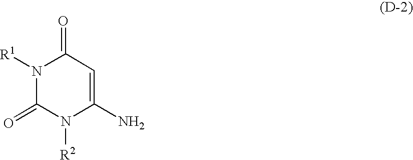

in which R¹ and R² independently of one another represent hydrogen or an unbranched or branched, linear or cyclic alkyl group containing 1 to 18 carbon atoms or an aryl group containing 6 to 18 carbon atoms which may optionally be substituted by one or more alkyl groups each containing 1 to 6 carbon atoms. Dimethylaminouracil (D-2*) is most particularly preferred for the purposes of the invention.

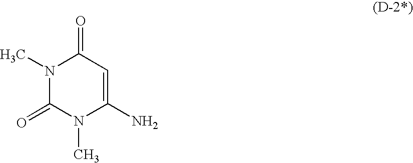

The compounds d3) are perchlorates. Perchlorates in the context of the present invention are metal salts and ammonium salts of perchloric acid. Examples of perchlorates suitable for the purposes of the invention are those corresponding to the formula M(ClO₄)ₙ, where M stands in particular for ammonium, Li, Na, K, Mg, Ca, Sr, Zn, Al, La or Ce. The index n has a value of 1, 2 or 3 according to the valency of the cation M. The perchlorate salts may be complexed with or dissolved in alcohols, for example polyols, cyclodextrins or ether or ester alcohols. Ester alcohols also include polyol partial esters. In the case of polyhydric alcohols or polyols, dimers, trimers, oligomers and polymers thereof—such as di-, tri-, tetra and polyglycols and di-, tri- and tetrapentaerythritol or polyvinyl alcohols in various degrees of polymerization—may also be used. Perchlorate/alcohol complexes specifically include the types known to the expert from EP-B-394 547, page 3, lines 37 to 56.

The perchlorate salts may be used in the form of various standard preparations, for example as salts or solutions in water or an organic solvent either as such or applied to a carrier material, such as PVC, Ca silicate, zeolites or hydrotalcites or “bound” by chemical reaction into a hydrotalcite or another layer lattice compound. Preferred polyol partial ethers are glycerol monoethers and glycerol monothioethers.

The perchlorates may be used either individually or in the form of mixtures with one another.

The compounds d4) are zeolites. As known to the expert, zeolites are alkali metal or alkaline earth metal alumosilicates which correspond to general formula (D-4):

M_{x/n}[(AlO₂)ₓ(SiO₂)_{y}].wH₂O (D-4)

in which

n is the charge of the cation M;

M is an element of the first or second Main Group, such as Li, Na, K, Mg, Ca, Sr or Ba;

y:x is a number of 0.8 to 15, preferably 0.8 to 1.2; and

w is a number of 0 to 300, preferably 0.5 to 30.

Examples of zeolites are sodium alumosilicates corresponding to the following formulae:

Na₁₂Al₁₂Si₁₂O₄₈.27 H₂O [zeolite A],

Na₆Al₆Si₆O₂₄.2 NaX.7.5 H₂O, X═OH, halogen, ClO₄ [sodalite];

Na₆Al₆Si₃₀O₇₂.24 H₂O;

Na₈Al₈Si₄₀O₉₆.24 H₂O;

Na₁₆Al₁₆Si₂₄O₈₀.16 H₂O;

Na₁₆ Al₁₆Si₃₂O₉₆.16 H₂O;

Na₅₆Al₅₆Si₁₃₆O₃₈₄.250 H₂O [zeolite Y],

Na₈₆Al₈₆Si₁₀₆O₃₈₄.264 H₂O [zeolite X];

or the zeolites obtainable by partial or complete replacement of the Na atoms by Li, K, Mg, Ca, Sr or Zn atoms, such as

(Na,K)₁₀Al₁₀Si₂₂O₆₄.20 H₂O;

Ca_{4.5}Na₃[(AlO₂)₁₂(SiO₂)₁₂].30 H₂O;

K₉Na₃[(AlO₂)₁₂(SiO₂)₁₂].27 H₂O.

Preferred zeolites correspond to the following formulae:

Na₁₂Al₁₂Si₁₂O₄₈.27 H₂O [zeolite A],

Na₆A1₆Si₆O₂₄.2NaX. 7.5 H₂O, X═OH, Cl, ClO₄, ½CO₃ [sodalite]

Na₆Al₆Si₃₀ O₇₂.24 H₂O,

Na₈Al₈Si₄₀ O₉₆.24 H₂O,

Na₁₆Al₁₆Si₂₄O₈₀.16 H₂O,

Na₁₆Al₁₆Si₃₂O₉₆.16 H₂O,

Na₅₆Al₅₆Si₁₃₆O₃₈₄.250 H₂O, [zeolite Y]

Na₈₆Al₈₆Si₁₀₆O₃₈₄.264 H₂O [zeolite X]

and zeolites X and Y with an Al:Si ratio of ca. 1:1 or the zeolites obtainable by partial or complete replacement of the Na atoms by Li, K, Mg, Ca, Sr or Zn atoms, such as

(Na,K)₁₀Al₁₀Si₂₂O₆₄.20 H₂O;

Ca_{4.5}Na₃ [(AlO₂)₁₂(SiO₂)₁₂].30 H₂O;

K₉Na₃[(AlO₂)₁₂(SiO₂)₁₂].27 H₂O.

The zeolites mentioned may also have a relatively low water content or may be water-free Other suitable zeolites are:

Na₂O.Al₂O₃.(2 to 5) SiO₂.(3.5 to 10) H₂O [zeolite P]

Na₂O.Al₂O₃.2 SiO₂.(3.5-10)H₂O (zeolite MAP)

or the zeolites obtainable by complete or partial replacement of the Na atoms by Li, K or H atoms, such as

(Li,Na,K,H)₁₀Al₁₀Si₂₂O₆₄.20 H₂O

K₉Na₃[(AlO₂)₁₂(SiO₂)₁₂].27 H₂O

K₄Al₄Si₄O₁₆.6H₂O [zeolite K-F]

Na₈Al₈Si₄₀O₉₆.24 H₂O zeolite D, as described in Barrer at al., J. Chem. Soc. 1952, 1561-71 and in U.S. Pat. No. 2,950,952.

The following zeolites are also suitable: K-offretite, zeolite R, zeolite LZ-217, Ca-free zeolite LZ-218, zeolite T, zeolite LZ-220, Na₃K₆Al₉Si₂₇O₇₂.21 H₂O [zeolite L]; zeolite LZ-21 1, zeolite LZ-212, zeolite O, zeolite LZ-217, zeolite LZ-219, zeolite Rho, zeolite LZ-214, zeolite ZK-19, zeolite W (K-M), Na₃₀Al₃₀Si₆₆O₁₉₂.98 H₂O [zeolite ZK-5, zeolite Q]. So far as these zeolites are concerned, reference is expressly made to EP-A 768 336 and the literature cited therein (cf. EP-A 768 336, page 26, lines 40 to 54).

A particularly preferred embodiment is characterized by the use of P-type zeolites corresponding to formula II in which X is a number of 2 to 5 and y is a number of 3.5 to 10. Zeolite MAP of formula II, in which x has a value of 2 and y a value of 3.5 to 10, are most particularly suitable. More particularly, this zeolite is zeolite Na-P, i.e. M stands for Na. This zeolite generally occurs in the variants Na-P-1, Na-P-2 and Na-P-3 which differ in their cubic, tetragonal or orthorhombic structure (cf. EP-A 768 336, the paragraph linking pages 26 and 27).

Fine-particle water-insoluble sodium alumosilicates which are precipitated and crystallized in the presence of water-soluble inorganic or organic dispersants are also suitable for the purposes of the invention. The dispersants may be introduced into the reaction mixture in any way before or during the precipitation or crystallization step.

Na zeolite A and Na zeolite P are most particularly preferred for the purposes of the invention.

The compounds d5) are cationic layer lattice compounds—compounds known to the relevant expert of which the structure and production are described, for example, by W. T. Reichle in Chemtec (January 1986), pages 58-63. The prototype of cationic layer lattice compounds is the mineral hydrotalcite [Mg₆Al₂(OH)₁₆](CO₃).4H₂O. Structurally, hydrotalcite derives from brucite [Mg(OH)₂]. Brucite crystallizes in a layer structure with the metal ions in octahedral vacancies between two layers of hexagonally close-packed (OH³¹ ) ions. Only every second layer of the octahedral vacancies is occupied by metal ions M so that layer packages (OH)—M—(OH) are formed. In brucite, the interlayers are empty. In hydrotalcite, some of the Mg(II) ions—say every second to fifth—are statistically replaced by Al(III) ions. Overall, the layer package thus receives a positive charge. This charge is equalized by anions which are present in the interlayers together with readily removable water of crystallization. Scheme 1 below diagrammatically illustrates the layer structure of hydrotalcite:

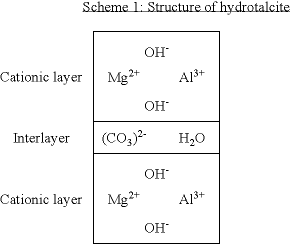

Hydrotalcites form powders with BET surfaces of up to about 150 m²/g which have a talcum-like feel. Two basic syntheses are known from the literature. The first comprises treating aqueous solutions of the corresponding metal salts with lye, the hydrotalcite formed precipitating. The second synthesis starts out from water-insoluble starting compounds, such as metal oxides and hydroxides. The reactions involved are heterogeneous reactions which are normally carried out in an autoclave.

As already mentioned, hydrotalcite is merely the prototype of cationic layer compounds. However, the synthesis methods known from hydrotalcite are also generally used for the synthesis of cationic layer compounds. As known to the expert, these synthesis methods may be classified quite generally as hydrothermal syntheses. Hydrothermal synthesis in the narrower sense is the synthesis of minerals from highly heated (>100° C./1 atm.) aqueous suspensions. Hydrothermal syntheses are generally carried out in pressure vessels because the temperatures applied are far above the boiling point of water and, in most cases, even above its critical temperature.

Cationic layer lattice compounds d5) in the context of the invention are understood to be compounds corresponding to general formula (D-5):

[EₑZ_{z}D_{d}Vᵥ(OH⁻)ₓ](Aⁿ⁻)ₐ.q H₂O (D-5)

in which

E is a monovalent cation from the group of alkali metals,

e is a number of 0 to 2,

Z is a divalent metal cation,

z is a number of 0 to 6,

D is a trivalent metal cation,

d is a number of 0 to 3,

V is a tetravalent metal cation,

v is a number of 0 to 1,

(Aⁿ⁻) is an acid anion with the charge n- where n is an integer of 1 to 3,

q is a number of 1 to 10,

with the proviso that x>a and e+2z+3d+4v=x+na.

In one embodiment, v in general formula (D-5) has the value zero. Accordingly, these layer compounds may be described by general formula (D-5*):

[EₑZ_{z}D_{d}(OH⁻)ₓ](Aⁿ⁻)ₐ.q H₂O (D-5*)

in which

E is a monovalent cation from the group of alkali metals,

e is a number of 0 to 2,

Z is a divalent metal cation,

z is a number of 0 to 6,

D is a trivalent metal cation,

d is a number of 0 to 3,

(Aⁿ⁻) is an acid anion with the charge n-, where n is an integer of I to 3, and

q is a number of 1 to 10,

with the proviso that x>a and e+2z+3d=x+na.

In another embodiment, e in general formula (D-5) has the value zero. Accordingly, these layer compounds may be described by general formula (D-5**):

[Z_{z}D_{d}Vᵥ(OH⁻)ₓ](Aⁿ⁻)ₐ.q H₂O (D-5**)

in which

E is a divalent metal cation,

z is a number of 0 to 6,

D is a trivalent metal cation,

d is a number of 0 to 3,

V is a tetravalent metal cation,

v is a number of 0 to 1,

(Aⁿ⁻) is an acid anion with the charge n- where n is an integer of 1 to 3,

q is a number of 1 to 10,

with the proviso that x>a and 2z+3d+4v=x+na.

In another preferred embodiment, e and v in general formula (D-5) each have the value zero. Accordingly, these layer compounds may be described by general formula (D-5***):

[Z_{z}D_{d}(OH⁻)ₓ](Aⁿ⁻)ₐ.q H₂O (D-5***)

in which

Z is a divalent metal cation,

z is a number of 0 to 6,

D is a trivalent metal cation,

d is a number of 0 to 3,

(Aⁿ⁻) is an acid anion with the charge n- where n is an integer of 1 to 3,

q is a number of 1 to 10,

with the proviso that x>a and 2z+3d=x+na.

Accordingly, so far as their composition is concerned, the layer compounds corresponding to formula (D-5***) have the structure of “classic” hydrotalcites known to the expert. Of these compounds, those where D is aluminium, d is the number 1 and z is a number of 1 to 5 are preferred. These special hydrotalcites are characterized by general formula (D-5****):

[Z_{z}Al(OH⁻)ₓ](Aⁿ⁻)_{z}.q H₂O (D-5****)

in which

Z is a divalent metal cation,

z is a number of 1 to 5,

(Aⁿ⁻) is an acid anion with the charge n- where n is an integer of I to 3,

q is a number of 1 to 10,

with the proviso that x>a and 2z+3d=x+na.

Cationic layer compounds (D-5) in which Z represents at least one divalent metal ion selected from the group consisting of magnesium, calcium and zinc are preferred for the purposes of the invention. In a preferred embodiment, Z represents exactly one divalent metal ion from the group mentioned, more particularly magnesium. Cationic layer compounds corresponding to general formula 1, in which Aⁿ⁻ represents an acid anion having a charge of (n-) selected from the group of anions consisting of carbonate, hydrogen carbonate, perchlorate, acetate, nitrate, tartrate, oxalate and iodide, preferably carbonate, are most particularly preferred. Where reference is made to at least one divalent metal ion in the explanation of formula I above, it means that different divalent metal ions may also be present alongside one another in the cationic layer compound. The indices x, y and z and m may represent whole or broken numbers within the limits mentioned. Cationic layer compounds corresponding to general formula (D-5), in which Z represents magnesium and Aⁿ⁻ represents carbonate, are particularly advantageous.

The compounds d6) are so-called CHAP compounds. These are calcium hydroxy aluminium (hydrogen) phosphites and/or hydrates thereof. These compounds have the general formula (D-6a):

CaₓAl₂(OH)ₓ₍ₓ₊₂₎HPO₃.mH₂O (D-6a)

in which

x is a number of 2 to 8 and

m is a number of 0 to 12,

or the general formula (D-6b):

CaₓAl₂(OH)_{2(x+3-y)}(HPO₃)_{y}.mH₂O (D-6b)

in which

x is a number of 2 to 12,

2x+5)/2>y>0 and

m is a number of 0 to 12

with the proviso that y is not 1 where x has a value of 2 to 8.

The CHAP compounds may be prepared, for example, by a process in which mixtures of calcium hydroxide and/or calcium oxide, aluminium hydroxide and sodium hydroxide or mixtures of calcium hydroxide and/or calcium oxide and sodium aluminate are reacted with phosphorous acid in aqueous medium in quantities sufficient for the preparation of the required calcium aluminium hydroxy hydrogen phosphates and the reaction product is removed and recovered in known manner. The reaction product directly formed in the above-described reaction may be removed from the aqueous reaction medium in known manner, preferably by filtration. The reaction product removed is also worked up in known manner, for example by washing the filter cake with water and drying the washed residue at temperatures of, for example, 60 to 130° C. and preferably at temperatures of 90 to 120° C.

Both fine-particle active aluminium hydroxide in combination with sodium hydroxide and a sodium aluminate may be used for the reaction. Calcium may be used in the form of fine-particle calcium oxide or calcium hydroxide or mixtures thereof. The phosphorous acid may be used in various concentrations. The reaction temperatures are preferably between 50 and 100° C. and more preferably between about 60 and 85° C. Catalysts and accelerators are not necessary, but are not problematical. The water of crystallization may be completely or partly removed from the compounds by heat treatment.

Where they are used as stabilizers, the dried calcium hydroxy aluminium hydroxyphosphites do not give off any water at the processing temperatures of 160-200° C. typically used for rigid PVC so that no troublesome bubbles are formed in the moldings.

To improve their dispersibility in halogen-containing thermoplastic resins, the CHAP compounds may be coated in known manner with surfactants.

The compounds d7) are katoites. These are compounds with the structure (D-7):

Ca₃Al₂(OH)₁₂.mH₂O (D-7)

in which m is a number of 0 to 10. The katoites may optionally be surface-modified. They have a quite specific crystal lattice (so-called hydrogarnet structure) which distinguishes them from other calcium aluminium hydroxy compounds. This crystal lattice together with lattice intervals is described in the article by C. Cohen-Addad and P. Ducros in Acta Cryst. (1967), 23, pages 220 to 225. Accordingly, the crystal lattice is a cubic crystal lattice. The aluminium is octahedrally surrounded by six oxygens of which each still carries a hydrogen. The calcium is surrounded by 8 oxygens which form a disturbed cube also known as a triangular dodecahedron.

The katoites with the general formula Ca₃Al₂(OH)₁₂ may be prepared from the hydroxides of calcium and aluminium in corresponding stoichiometric quantities in aqueous medium, for example in accordance with DE 2 424 763. The katoites are obtained with different mean particle according to the temperatures and reaction times used in their production.

Temperatures of 50 to 150° C. and reaction times of 0.1 to 9 hours are preferred. Under these conditions, the katoites are obtained with mean particle diameters of 0.1 μm to 100 μm and preferably with mean particle diameters of 0.5 to 30 μm. Small quantities of calcium-containing hydroxy-aluminates (hydrocalumites), which have a layer structure and which substantially correspond to the general formula shown above, can be formed as a secondary product. Excesses of aluminium or calcium hydroxide may also be used in the production of the katoites, in which case mixtures of unreacted calcium and/or aluminium hydroxide and katoite are formed. These mixtures may also be used for the purposes of the invention. If desired, the katoites corresponding to the above formula may be surface-modified with one or more additives selected from the following groups:

v-a) optionally alkoxylated alcohols containing one or more hydroxyl groups,

v-b) partly or completely epoxidized unsaturated fatty acids, fatty alcohols and/or derivatives thereof,

v-c) full and partial esters of polyols containing 3 to 30 carbon atoms and 2 to 6 hydroxyl groups with carboxylic acids containing 6 to 22 carbon atoms,

v-d) alkyl and aryl phosphites,

v-e) homopolymers and copolymers of acrylic acid and methacrylic acid,

v-f) lignin and naphthalene sulfonates and/or trimer fatty acids,

v-g) salts of fatty acids.

Suitable group v-a) additives are both monohydric alcohols and polyols containing 3 to 30 carbon atoms and 2 to 6 hydroxyl groups which may optionally be alkoxylated, preferably ethoxylated. Preferred monohydric alcohols are fatty alcohols containing 6 to 22 carbon atoms, such as capric, lauryl, palmityl, stearyl, oleyl, linoleyl, arachidyl and behenyl alcohol and the technical mixtures thereof obtainable from natural oils and fats. Of these fatty alcohols, ethoxylated representatives containing 2 to 15 mol ethylene oxide are most particularly preferred. Suitable polyols are diols containing 3 to 30 carbon atoms, such as butanediols, hexanediols, dodecanediols, and trimethylol propane, pentaerythritol, glycerol and technical oligomer mixtures thereof with average degrees of condensation of 2 to 10. Particularly preferred polyols are those containing 3 to 30 carbon atoms and at least one hydroxyl group or one ether oxygen for every 3 carbon atoms, glycerol and/or technical oligoglycerol mixtures with average degrees of condensation of 2 to 10 being most particularly preferred.

The group v-b) additives are partly or completely epoxidized unsaturated fatty acids or fatty alcohols containing 6 to 22 carbon atoms or derivatives thereof. Particularly suitable derivatives of the epoxidized fatty acids or fatty alcohols are the esters which may be obtained by esterifying the epoxidized fatty acids and epoxidized fatty alcohols with one another or even with non-epoxidized carboxylic acids or non-epoxidized monohydric or polyhydric alcohols. The epoxidized fatty acids are preferably derived from unsaturated palmitoleic, oleic, elaidic, petroselic, ricinoleic, linolenic, gadoleic or erucic acid which may be completely or partly epoxidized by known methods. The epoxidized fatty alcohols are preferably derived from the unsaturated alcohols oleyl, elaidyl, ricinoleic, linoleyl, linolenyl, gadoleyl, arachidonic or erucic alcohol which may also be completely or partly epoxidized by known methods. Suitable esters of epoxidized fatty acids are esters of monohydric, dihydric and/or trihydric alcohols which are completely esterified with epoxidized unsaturated carboxylic acids containing 6 to 22 carbon atoms, such as methyl, 2-ethylhexyl, ethylene glycol, butanediol, neopentyl glycol, glycerol and/or trimethylol propane esters of epoxidized lauroleic acid, palmitoleic acid, oleic acid, ricinoleic acid, linoleic acid and/or linolenic acid. Esters of trihydric alcohols and almost completely epoxidized unsaturated carboxylic acids containing 12 to 22 carbon atoms are preferred, esters of glycerol with almost completely epoxidized unsaturated carboxylic acids containing 12 to 22 carbon atoms being particularly preferred. As usual in oleochemistry, the epoxidized carboxylic acid glycerides may also be technical mixtures of the type obtained by epoxidation of natural unsaturated fats and unsaturated oils. Epoxidized rapeseed oil, epoxidized soybean oil and epoxidized sunflower oil from new plants are preferably used.

The group v-c) additives are full or partial esters obtained by the relevant methods of preparative organic chemistry, for example by acid-catalyzed reaction of polyols with carboxylic acids. The polyol component may be selected from the polyols already discussed in connection with group a). Preferred acid components are aliphatic, saturated and/or unsaturated carboxylic acids containing 6 to 22 carbon atoms, such as caproic acid, caprylic acid, capric acid, lauric acid, myristic acid, palmitic acid, palmitoleic acid, stearic acid, oleic acid, ricinoleic acid, linoleic acid, linolenic acid, behenic acid or erucic acid. As usual in oleochemistry, the carboxylic acid component may also be a technical mixture of the type obtained in the pressure hydrolysis of natural fats and oils. Partial esters of glycerol and, in particular, technical oligoglycerol mixtures having average degrees of condensation of 2 to 10 with saturated and/or unsaturated aliphatic carboxylic acids containing 6 to 22 carbon atoms are preferred.

Finally, the group v-d) additives may be alkyl and aryl phosphites, preferably those corresponding to general formula (II):

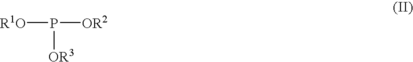

in which R¹, R² and R³ independently of one another represent an alkyl group containing 1 to 18 carbon atoms or a phenyl group. Typical examples of group d) additives are tributyl phosphite, triphenyl phosphite, dimethyl phenyl phosphite and/or dimethyl stearyl phosphite. Diphenyl decyl phosphite is preferred.

The group v-e) additives are preferably polymers of acrylic acid and methacrylic acid and copolymers thereof. The expression “copolymers” is used in a dual sense, namely: on the hand as pure copolymers of acrylic acid and methacrylic acid and on the other hand as copolymers of (meth)acrylic acid with other vinylically unsaturated polymerizable monomers. Examples of other polymerizable monomers are unsaturated monomers containing sulfonic and phosphonic acid groups, unsaturated aliphatic carboxylic acids containing 3 to 5 carbon atoms, amides of unsaturated aliphatic carboxylic acids containing 3 to 5 carbon atoms, aminofunctional unsaturated monomers and/or salts thereof, vinyl acetate, acrolein, vinyl chloride, acrylonitrile, vinylidene chloride, 1,3-butadiene, styrene, alkyl styrenes containing 1 to 4 carbon atoms in the alkyl group. Examples of group v-e) additives are polyacrylic acid, polymethacrylic acid (acrylic acid and methacrylic acid are referred to hereinafter in short as (meth)acrylic acid or derivatives) and/or salts thereof, such as polysodium (meth)acrylate, copolymers of (meth)acrylic acid with maleic acid, maleic anhydride, styrene sulfonic acid, α-methyl styrene, 2-vinyl pyridine, 1-vinyl imidazole, dimethylaminopropyl (meth)acrylamide, 2-(meth)acrylamido-2-methyl propane sulfonic acid, (meth)acrylamide, N-hydroxydimethyl (meth)acrylamide and/or salts thereof. Most particularly preferred polymeric additives are those which are predominantly anionic in character, i.e. those which contain a majority of acid groups either in free form or in the form of their salts. Polymers of (meth)acrylic acid and copolymers thereof with styrene, acrolein, alkyl styrenes containing 1 to 4 carbon atoms in the alkyl group, styrene sulfonic acid, maleic acid and/or salts thereof, particularly sodium salts, and maleic anhydride are particularly preferred. The polymeric group e) additives preferably have a molecular weight in the range from 1,000 to 10,000. The polymeric additives may be produced by known methods, such as bulk or solution polymerization.

The group v-g) additives are salts of fatty acids. Suitable fatty acids have already been mentioned in connection with the group v-c) additives. Alkali metal salts of the saturated fatty acids are preferred.

One or more additives from one or more of groups v-a) to v-g) may be used to modify the katoites, the total quantity of additives being from 0.1 to 10% by weight, based on katoite. Where combinations of the polymeric additives v-e) with other additives from group v-a) to group v-d) and group v-f) to group v-g) are used, it is preferred to have the additives in quantities of 50 to 90% by weight, based on the total quantity of additives. Particularly preferred surface-modified katoites are those which are modified with one or more additives from groups v-b), v-e) and v-g).

The katoites may be modified either in situ or subsequently.

Where they are subsequently modified, the katoites are thoroughly ground with organic or aqueous solutions of the additives, preferably in a mill, more preferably a ball mill, and are then usually dried. If the additives are liquid or low-melting at room temperature, solutions thereof should not of course be used. Otherwise, clear aqueous solutions or solutions with polar organic solvents are best used in the case of additives v-a) to v-g).

In the context of the invention, polar organic solvents are understood to be hydrocarbon compounds liquid at room temperature (15 to 25° C.) which contain at least one substituent more electronegative than carbon. Corresponding hydrocarbon compounds include chlorinated hydrocarbons, alcohols, ketones, esters, ethers and/or glycol ethers. Suitable polar organic solvents are methanol, ethanol, n-butanol, acetone, methyl ethyl ketone, methyl isobutyl ketone, cyclohexanol, isophorone, ethyl acetate, lactic acid ethyl ester, 2-methoxyethyl acetate, tetrahydrofuran, ethyl glycol monomethyl ether, diethylene glycol monoethyl ether.

To ensure that the surface of the katoites can be uniformly modified, it is appropriate—where group v-e) additives are present—for these additives to be soluble in polar organic solvents of the described type and/or in water with pH values of 8 to 12. “Soluble” in this context means that at least 0.01% by weight and preferably 0.1% by weight, based on solution, of the polymeric additives v-e) dissolves completely clearly in the polar organic solvents and in an aqueous solution with a pH value of 10 (adjusted with alkali metal hydroxides at 20° C.), more particularly under the conditions described above.

The katoites may also be modified in situ, i.e. the additives may be added, optionally in the form of their solutions, to the calcium and aluminium hydroxide solutions from which the katoite is formed.

Lastly, however, the two forms of modification may also be combined with one another which is recommended for modification with several additives differing in particular in their dissolving behaviour.

The compounds d8) are glycidyl compounds. They contain the glycidyl group:

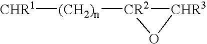

which is directly attached to carbon, oxygen, nitrogen or sulfur atoms. In the formula, either R¹ and R³ are both hydrogen, R² is hydrogen or methyl and n=0 or R¹ and R³ together represent —CH₂—CH₂— or —CH₂—CH₂—CH₂—, in which case R² is hydrogen and n=0 or 1.

Examples of suitable glycidyl compounds are those belonging to groups d8-I) to d8-V) described below.

Compounds of Group d8-I)

Glycidyl and β-methylglycidyl esters obtainable by reaction of a compound containing at least one carboxyl group in the molecule and epichlorohydrin or glycerol epichlorohydrin or b-methyl epichlorohydrin. The reaction is preferably carried out in the presence of bases.

Aliphatic carboxylic acids may be used as the compounds containing a carboxyl group in the molecule. Examples of such carboxylic acids are glutaric acid, adipic acid, pimelic acid, suberic acid, azelaic acid, sebacic acid or dimerized or trimerized linoleic acid, acrylic and methacrylic acid, caproic acid, caprylic acid, lauric acid, myristic acid, palmitic acid, stearic acid and pelargonic acid.

However, cycloaliphatic carboxylic acids, for example cyclohexane carboxylic acid, tetrahydrophthalic acid, 4-methyltetrahydrophthalic acid, hexahydrophthalic acid or 4-methylhexahydrophthalic acid, may also be used.

In addition, aromatic carboxylic acids, for example benzoic acid, phthalic acid, isophthalic acid, trimellitic acid or pyromellitic acid, may be used.

Carboxyl-terminated adducts, for example of trimellitic acid and polyols, such as glycerol or 2,2-bis-(4-hydroxycyclohexyl)-propane, may also be used.

Compounds of Group d8-II)

Glycidyl or (β-methylglycidyl) ethers obtainable by reacting a compound containing at least one free alcoholic hydroxy group and/or phenolic hydroxy group and a suitably substituted epichlorohydrin under alkaline conditions or in the presence of an acidic catalyst and subsequent alkali treatment.

Ethers of this type are derived, for example, from acyclic alcohols, such as ethylene glycol, diethylene glycol and higher poly-(oxyethylene)-glycols, propane-1,2-diol or poly-(oxypropylene)-glycols, propane-1,3-diol, butane-1,4-diol, poly-(oxytetramethylene)-glycols, pentane-1,5-diol, hexane-1,6-diol, hexane-2,4,6-triol, glycerol, 1,1,1-trimethylolpropane, bis-trimethylol propane, pentaerythritol, sorbitol, and from polyepichlorohydrins, butanol, amylalcohol, pentanol, and from monohydric alcohols, such as iso-octanol, 2-ethylhexanol, isodecanol and C₇₋₉ alkanol and C₉₋₁₁ alkanol mixtures.

However, they are also derived, for example, from cycloaliphatic alcohols, such as 1,3- or 1,4-dihydroxycyclohexane, bis-(4-hydroxycyclohexyl)-methane, 2,2-bis-(4-hydroxycyclohexyl)-propane or 1,1-bis-(hydroxymethyl)-cyclohex-3-ene, or have aromatic nuclei, such as N,N-bis-(2-hydroxyethyl)-aniline or p,p′-bis-(2-hydroxyethylamino)-diphenyl-methane.

The epoxy compounds may also be derived from mononuclear phenols, for example from phenol, resorcinol or hydroquinone, or are based on polynuclear phenols, for example on bis-(4-hydroxyphenyl)-methane, 2,2-bis-(4-hydroxyphenyl)-propane, 2,2-bis-(3,5-dibromo-4-hydroxyphenyl)-propane, 4,4′-dihydroxydiphenylsulfone, or on phenol/formaldehyde condensates obtained under acidic conditions, such as phenol novolaks.

Other possible terminal epoxides are, for example, glycidyl-1-naphthyl ether, glycidyl-2-phenyl phenyl ether, 2-biphenyl glycidyl ether, N-(2,3-epoxypropyl)-phthalimide and 2,3-epoxypropyl-4-methoxyphenyl ether.

Compounds of Group d8-III)

(N-glycidyl) compounds obtainable by dehydrochlorination of the reaction products of epichlorohydrin with amines which contain at least one aminohydrogen atom. These amines are, for example, aniline, N-methyl aniline, toluidine, n-butylamine, bis-(4-aminophenyl)-methane, m-xylylenediamine or bis-(4-methylaminophenyl)-methane and also N,N,O-triglycidyl-m-aminophenol or N,N,O-triglycidyl-p-aminophenol.

However, the (N-glycidyl) compounds also include N,N′-di-, N,N′,N″-tri- and N,N′,N″,N′″-tetraglycidyl derivatives of cycloalkylene ureas, such as ethylene urea or 1,3-propylene urea, and N,N′-diglycidyl derivatives of hydantoins, such as 5,5-dimethylhydantoin, or glycoluril and triglycidylisocyanurate.

Compounds of Group d8-IV)

S-glycidyl compounds, such as di-S-glycidyl derivatives for example, derived from dithiols such as, for example, ethane-1,2-diol or bis-(4-mercaptomethylphenyl)-ether.

Compounds of Group d8-V)

Epoxy compounds containing a unit corresponding to formula 1, in which R₁ and R₃ together represent —CH₂—CH₂— and n=0, are bis-(2,3-epoxycyclopentyl)-ether, 2,3-epoxycyclopentyl glycidyl ether or 1,2-bis-(2,3-epoxycyclopentyloxy)-ethane. An example of an epoxy resin containing a unit of formula 1, in which R₁ and R₃ together are —CH₂—CH₂— and n=1, is 3,4-epoxy-6-methylcyclohexane carboxylic acid-(3′,4′-epoxy-6′-methyl-cyclohexyl)-methyl ester.

The following are examples of suitable terminal epoxides (™=®):

liquid bisphenol-A-diglycidyl ethers, such as Araldit™ GY 240, Araldit™ GY 250, Araldit™ GY 260, Araldit™ GY 266, Araldit™ GY 2600, Araldit™MY 790:

solid bisphenol-A-diglycidyl ethers, such as Araldit™ GT 6071, Araldit™ GT 7071, Araldit™ GT 7072, Araldit™ GT 6063, Araldit™ GT 7203, Araldit™ GT 6064, Araldit™ GT 7304, Araldit™ GT 7004, Araldit™ GT 6084, Araldit™ GT 1999, Araldit™ GT 7077, Araldit™ GT 6097, Araldit™ GT 7097, Araldit™ GT 7008, Araldit™ GT 6099, Araldit™ GT 6608, Araldit™ GT 6609, Araldit™ GT 6610;

liquid bisphenol-F-diglycidyl ethers, such as Araldit™ GY 281, Araldit™ PY 302, Araldit™ PY 306:

solid polyglycidyl ethers of tetraphenylethane, such as CG Epoxy Resin™ 0163:

solid and liquid polyglycidyl ethers of phenol/formaldehyde novolak, such as EPN 1138, EPN 1139, GY 1180, PY 307;

solid and liquid polyglycidyl ethers of o-cresol/formaldehyde novolak, such as ECN 1235, ECN 1273, ECN 1280, ECN 1299;

liquid glycidyl ethers of alcohols, such as Shell™ Glycidylether 162, Araldit™ DY 0390, Araldit™ DY 0391;

liquid glycidyl ethers of carboxylic acids, such as Shell™ Cardura E terephthalic acid ester, trimellitic acid ester, Araldit™ PY 284;

solid heterocyclic epoxy resins (triglycidyl isocyanurate), such as Araldit™ PT 810;

liquid cycloaliphatic epoxy resins, such as Araldit™ CY 179;

liquid N,N,O-triglycidyl ethers of p-aminophenol, such as Araldit™ MY 0510;

tetraglycidyl-4-4′-methylenebenzamine or N,N,N′,N′-tetraglycidyl-diaminophenylmethane such as Araldit™ MY 720, Araldit™ MY 721.

Epoxy compounds containing two functional groups are preferably used. However, epoxy compounds containing one, three or more functional groups may also be used.

Epoxy compounds, above all diglycidyl compounds, containing aromatic groups are mainly used.

A mixture of various epoxy compounds may also be used.

In a particularly preferred embodiment, diglycidyl ethers based on bisphenols, for example 2,2-bis-(4-hydroxyphenyl)-propane (bisphenol A), bis-(4-hydroxyphenyl)-methane or mixtures of bis-(ortho/para-hydroxyphenyl)-methane (bisphenol F), are used as the terminal epoxy compounds.

The terminal epoxy compounds may be used in a quantity of preferably at least 0.1 part, for example 0.1 to 50, more particularly 1 to 30 and most particularly 1 to 25 parts by weight, based on 100 parts by weight PVC.

The compounds d9) are β-diketones and β-ketoesters. Suitable 1,3-dicarbonyl compounds are linear or branched dicarbonyl compounds. A preferred embodiment is characterized by the use of dicarbonyl compounds corresponding to formula (D-9):

R¹—CO—CHR²—CO—R³ (D-9)

in which

R¹ represents C₁₋₂₂ alkyl, C₅₋₁₀ hydroxyalkyl, C₂₋₁₈ alkenyl, phenyl, OH—, C₁₋₄-alkyl-, C₁₋₄-alkoxy- or halogen-substituted phenyl, C₇₋₁₀ phenylalkyl, C₅₋₁₂ cycloalkyl, C₁₋₄-alkyl-substituted C₅₋₁₂ cycloalkyl or a group —R⁵—S—R⁶ or —R⁵—O—R⁶,

R² represents hydrogen, C₁₋₈ alkyl, C₂₋₁₂ alkenyl, phenyl, C₇₋₁₂ alkylphenyl, C₇₋₁₀ phenylalkyl or a group —CO—R⁴,

R³ has any of the meanings defined for R¹ or represents C₁₋₁₈ alkoxy,

R⁴ represents C₁₋₄ alkyl or phenyl,

R⁵ represents C₁₋₁₀ alkylene,

R⁶ represents C₁₋₁₂ alkyl, phenyl, C₇₋₁₈ alkylphenyl or C₇₋₁₀ phenylalkyl.

These include the hydroxyfunctional diketones of EP 346 279, the oxa- and thiadiketones of EP 307 358 and the ketoesters based on isocyanic acid of U.S. Pat. No. 4,339,383.

R¹ and R³ as alkyl may be in particular C₁₋₁₈ alkyl such as, for example, methyl, ethyl, n-propyl, isopropyl, n-butyl, tert.butyl, pentyl, hexyl, heptyl, octyl, decyl, dodecyl or octadecyl.

R¹ and R³ as hydroxyalkyl represent in particular a group —(CH₂)ₙ—OH in which n is 5, 6 or 7.

R¹ and R³ as alkenyl may be, for example, vinyl, allyl, methallyl, 1-butentyl, 1-hexenyl or oleyl, preferably allyl.

R¹ and R³ as OH—, alkyl-, alkoxy- or halogen-substituted phenyl may be, for example, tolyl, xylyl, tert.butylphenyl, methoxyphenyl, ethoxyphenyl, hydroxyphenyl, chlorophenyl or dichlorophenyl.

R¹ and R³ as phenylalkyl are, in particular, benzyl.

R² and R³ as cycloalkyl or alkylcycloalkyl are, in particular, cyclohexyl or methylcyclohexyl.

R² as alkyl may be, in particular, C₁₋₄ alkyl. R² as C₂₋₁₂ alkenyl may be, in particular, allyl. R² as alkylphenyl may be, in particular, tolyl. R² as phenylalkyl may be, in particular, benzyl. R² is preferably hydrogen. R³ as alkoxy may be, for example, methoxy, ethoxy, butoxy, hexyloxy, octyloxy, dodecyloxy, tridecyloxy, tetradecyloxy or octadecyloxy. R⁵ as C₁₋₁₀ alkylene is, in particular, C₂₋₄ alkylene. R⁶ as alkyl is, in particular, C₄₋₁₂ alkyl, such as, for example, butyl, hexyl, octyl, decyl or dodecyl. R⁶ as alkylphenyl is, in particular, tolyl. R⁶ as phenylalkyl is, in particular, benzyl.

Examples of 1,3-dicarbonyl compounds corresponding to the above formula are acetylacetone, butanoylacetone, heptanoylacetone, stearoylacetone, palmitoylacetone, lauroylacetone, benzoylacetone, dibenzoylmethane, lauroylbenzoylmethane, palmitoylbenzoylmethane, stearoylbenzoylmethane, isooctylbenzoylmethane, 5-hydroxycapronylbenzoylmethane, tribenzoylmethane, bis-(4-methylbenzoyl)-methane, benzoyl-p-chlorobenzoylmethane, bis-(2-hydroxybenzoyl)-methane, 4-methoxybenzoyl benzoylmethane, bis-(4-methoxybenzoyl)-methane, 1-benzoyl-1-acetylnonane, benzoylacetyl phenylmethane, stearoyl-4-methoxybenzoylmethane, bis-(4-tert-butylbenzoyl)-methane, benzoylformylmethane, benzoyl phenylacetylmethane, bis-cyclohexanoylmethane, dipivaloylmethane, 2-acetylcyclopentanone, 2-benzoylcyclopentanone, diacetoacetic acid methyl-, -ethyl- and -allylester, benzoyl-, propionyl- and butyryl acetoacetic acid methyl- and -ethyl ester, triacetylmethane, acetoacetic acid methyl-, -ethyl-, -hexyl-, -octyl-, -dodecyl- or -octadecylester, benzoylacetic acid methyl-, -ethyl-, -butyl-, -2-ethylhexyl-, -dodecyl- or -octadecylester and propionyl- and butyrylacetic acid C₁₋₁₈ alkylester. Stearoylacetic acid ethyl-, -propyl-, -butyl-, -hexyl- or -octylester and the polynuclear β-ketoesters described in EP 433 230 and dehydroacetic acid and zinc, magnesium or alkali metal salts thereof.

1,3-Diketo compounds corresponding to the above formula, in which R¹ is C₁₋₁₈ alkyl, phenyl, OH—, methyl- or methoxy-substituted phenyl, C₇₋₁₀ phenylalkyl or cyclohexyl, R² is hydrogen and R³ has any of the meanings defined for R¹, are preferred.

The 1,3-dicarbonyl compounds corresponding to the above formula may be used individually, in the form of mixtures and/or as alkali metal, alkaline earth metal and zinc chelates.

The 1,3-diketo compounds may be used in a quantity of, for example, 0.01 to 10, preferably 0.1 to 3 and more particularly 0.01 to 2 parts by weight, based on 100 parts by weight PVC.

The compounds d10) are dihydropyridines and polydihydropyridines. Suitable monomeric dihydropyridines are the compounds described, for example, in FR 2 039 496, EP 2 007, EP 362 012 and EP 24 754. Preferred compounds d10) correspond to formula (D-10):

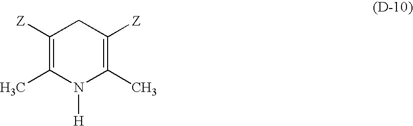

where Z is CO₂CH₃, CO₂C₂H₅, CO₂ⁿC₁₂H₂₅ or —CO₂C₂H₄—S—ⁿC₁₂H₂₅. The superscripted n means that the C₁₂H₂₅ alkyl group is unbranched.

Suitable polydihydropyridines are, above all, compounds corresponding to the following formula:

T-X-R-X-R′-X-L

where

X represents

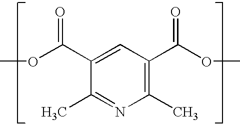

T represents unsubstituted C₁₋₁₂alkyl,

L has the same meanings as T,

m and n are numbers of 0 to 20,

k is the number 0 or 1,

R and R′ independently of another represent ethylene, propylene, butylene or an alkylene or cycloalkylene-bis-methylene group of the type —(—CₚH₂ₚ—X—)ₜCₚH₂ₚ—,

p is a number of 2 to 8,

t is a number of 0 to 10,

X is oxygen or sulfur.

Such compounds are described in EP 286 887.

The (poly)dihydropyridines may be used in the chlorine-containing polymer in a quantity of 0.001 to 5 and more particularly 0.005 to 1 part by weight, based on the polymer.

Thiodiethylene-bis-[5-methoxycarbonyl-2,6-dimethyl-1,4-dihydropyridine-3-carboxylate] and thiodiethylene-bis-[5-methoxycarbonyl-2,6-dimethyl-1,4-dihydropyridine-3-carboxylate are particularly preferred.

The compounds d11) are polyols and polyol derivatives. Particularly suitable polyols are, for example, pentaerythritol, dipentaerythritol, tripentaerythritol, bis-trimethylolpropane, inositol, polyvinyl alcohol, bis-trimethylolethane, tris-methylolpropane, sorbitol, maltitol, isomaltitol, lactitol, lycasin, mannitol, lactose, leucrose, tris-(hydroxylethyl)-isocyanurate (THEIC), palatinite, tetramethylol cyclohexanol, tetramethylol cyclopentanol, tetramethylol cyclopyranol, glycerol, diglycerol, polyglycerol or thiodiglycerol and reaction products of these polyols with ethylene oxide and/or propylene oxide.

The polyols may optionally be esterified or etherified at one or more OH groups. Preferred polyol derivatives are esters of polyols with carboxylic acids, for example glycerol partial esters of fatty acids, for example glycerol monooleate, glycerol dioleate, glycerol monostearate, glycerol distearate, pentaerythritol or TMP partial esters or esters of dicarboxylic acids (for example adipic acid, maleic acid) with polyols, such as pentaerythritol, glycerol or trimethylolpropane.

The polyols or polyol derivatives may be used individually or in admixture with one another.

The polyols or polyol derivatives may be used in a quantity of, for example, 0.01 to 20, preferably 0.1 to 20 and more particularly 0.1 to 10 parts by weight, based on 100 parts by weight halogen-containing organic plastic.

Examples of suitable compounds d12) can be found on page 7, line 22 to page 25, line 21 of the above-cited EP-A-768 336. The sterically hindered amines mentioned there are expressly included in the disclosure of the present invention.

Examples of suitable compounds d13) can be found on page 27, line 17 to page 28, line 9 of the above-cited EP-A-768 336. The dawsonites mentioned there are expressly included in the disclosure of the present invention.

The compounds d14) are alkali metal and alkaline earth metal compounds. These are mainly understood to be the carboxylates of the acids described under d27), but also corresponding oxides or hydroxides or (hydrogen)carbonates. Mixtures with organic acids may also be used. Examples include NaOH, Na stearate, Na bicarbonate, KOH, potassium stearate, potassium bicarbonate, LiOH, Li₂CO₃, Li stearate, CaO, Ca(OH)₂, MgO, Mg(OH)₂, Mg stearate, CaCO₃, MgCO₃ and dolomite, huntite, chalk, basic Mg carbonate and other Na and K salts of fatty acids.

In the case of alkaline earth metal and Zn carboxylates, adducts thereof with MO or M(OH)₂ (M═Ca, Mg, Sr or Zn), so-called “overbased” compounds, may also be used.

Alkali metal, alkaline earth metal and/or aluminium carboxylates are preferably used in addition to the stabilizer combination according to the invention.

Examples of suitable compounds d15) can be found on page 31, line 34 to page 33, line 4 of the above-cited EP-A-768 336. The antioxidants mentioned there are expressly included in the disclosure of the present invention.

With regard to the substances belonging to group d16), it is expressly pointed out that both slip agents and parting agents and mixtures of slip and parting agents may be used. In the standard language of the expert, parting agents are products which reduce the frictional resistances mainly between the polymer melt and the steel surface of the machine used for moulding/processing. The effect of the reduced frictional resistance is that the melt pressure is reduced. By contrast, slip agents mainly act in the polymer melt and reduce the internal friction forces so that, even with high filler contents, the melt retains good plastic flow which is important for filling the mould.

In one embodiment of the invention, the slip or parting agents used are calcium salts and/or magnesium salts and/or aluminium salts solid or liquid at 20° C. which are selected from

calcium salts of saturated or unsaturated, linear or branched monocarboxylic acids containing 6 to 36 carbon atoms,

calcium salts of unsubstituted or C₁₋₄-alkyl-substituted benzoic acid,

magnesium salts of saturated or unsaturated, linear or branched monocarboxylic acids containing 6 to 36 carbon atoms,

magnesium salts of saturated or unsaturated dicarboxylic acids containing 6 to 10 carbon atoms,

aluminium salts of saturated or unsaturated, linear or branched monocarboxylic acids containing 6 to 36 carbon atoms.

The above-mentioned calcium, magnesium and aluminium salts may be used both individually and in admixture with one another.

Other slip or parting agents which may be used individually or in combination with one another as component d16) are the substances known from the relevant prior art. Compounds of the following types are preferred: hydrocarbon waxes melting at temperatures of 70 to 130° C., oxidized polyethylene waxes, free fatty acids containing 8 to 22 carbon atoms and branched-chain isomers thereof, for example stearic acid or even hydroxystearic acid, α-olefins, wax esters, i.e. esters of relatively long-chain monocarboxylic acids and monoalcohols, primary and secondary, saturated and unsaturated higher alcohols preferably containing 16 to 44 carbon atoms in the molecule, ethylenediamine distearate, montanic acid esters of diols, for example ethanediol, butane-1,3-diol and glycerol, mixtures of such montanic acid esters with nonesterified montanic acids, partial esters of fatty acids containing 8 to 22 carbon atoms and polyols containing 2 to 6 carbon atoms and 2 to 6 hydroxyl groups which contain on average at least one free polyol hydroxyl group per molecule. Also suitable are the mixed esters of aliphatic, cycloaliphatic or aromatic dicarboxylic acids containing 2 to 22 carbon atoms in the molecule, aliphatic polyols containing 2 to 6 hydroxyl groups in the molecule and aliphatic monocarboxylic acids containing 12 to 30 carbon atoms in the molecule described in DE-C-19 07 768 with hydroxyl or acid values of 0 to 6. Examples include mixed esters of maleic acid/pentaerythritol/behenic acid, mixed esters of adipic acid/pentaerythritol/oleic acid and mixed esters of adipic acid/pentaerythritol/stearic acid. According to the invention, slip or parting agents of this type may be used individually and in combination with one another and with the above-mentioned calcium, magnesium or aluminium salts.

Examples of suitable compounds d17) can be found on page 29, line 20 to page 30, line 26 of the above-cited EP-A-768 336. The plasticizers mentioned there are expressly included in the disclosure of the present invention.

Examples of suitable compounds d18) can be found on page 30, line 28 to page 30, line 3 of the above-cited EP-A-768 336. The pigments mentioned there are expressly included in the disclosure of the present invention. Titanium dioxide is preferably used as the pigment d18).

Examples of suitable compounds d19) can be found on page 30, line 37 to page 30, line 43 of the above-cited EP-A-768 336. The fillers mentioned there are expressly included in the disclosure of the present invention. Among the fillers d19), calcium carbonate (chalk), talcum, kaolin and the like are preferred. Chalk is most particularly preferred.

Examples of suitable compounds d20) can be found on page 30, line 45 to page 31, line 3 of the above-cited EP-A-768 336. The phosphates mentioned there are expressly included in the disclosure of the present invention.

Examples of suitable compounds d21) can be found on page 31, line 5 to page 31, line 19 of the above-cited EP-A-768 336. The thiophosphites and thiophosphates mentioned there are expressly included in the disclosure of the present invention.

Examples of suitable compounds d22) can be found on page 31, line 21 to page 31, line 25 of the above-cited EP-A-768 336. The mercaptocarboxylic acid esters mentioned there are expressly included in the disclosure of the present invention.

Examples of suitable compounds d23) can be found on page 31, line 27 to page 31, line 32 of the above-cited EP-A-768 336. The epoxidized fatty acid esters mentioned there are expressly included in the disclosure of the present invention.

Examples of suitable compounds d24) can be found on page 33, line 6 to page 34, line 7 of the above-cited EP-A-768 336. The UV absorbers and photostabilizers mentioned there are expressly included in the disclosure of the present invention.

Examples of suitable compounds d25) can be found on page 35, line 9 to page 35, line 12 of the above-cited EP-A-768 336. The blowing agents mentioned there are expressly included in the disclosure of the present invention.

Compound d26) is urea and is therefore a compound of defined structure known to the expert.

The compounds d27) are metal soaps, more particularly soaps of the metals zinc, magnesium, calcium, aluminium, lead, barium, tin and cadmium.

The organic zinc compounds with a Zn—O— bond are zinc enolates and/or zinc carboxylates. The latter are, for example, compounds from the series of aliphatic saturated C₂₋₂₂ carboxylates, aliphatic unsaturated C₃₋₂₂ carboxylates, aliphatic C₂₋₂ carboxylates which are substituted by at least one OH group or of which the chain is interrupted by at least one 0 atom (oxa acids), cyclic and bicyclic carboxylates containing 5 to 22 carbon atoms, unsubstituted phenyl carboxylates, phenyl carboxylates substituted by at least one OH group and/or C₁₋₁₆-alkyl-substituted phenylcarboxylates, phenyl-C₁₋₁₆-alkyl carboxylates or optionally C₁₋₁₂-alkyl-substituted phenolates or abietic acid.

The following are mentioned by name as examples: zinc salts of monobasic carboxylic acids, such as acetic acid, propionic acid, butyric acid, valeric acid, hexanoic acid, oenanthic acid, octanoic acid, neodecanoic acid, 2-ethylhexanoic acid, pelargonic acid, decanoic acid, undecanoic acid, dodecanoic acid, tridecanoic acid, myristic acid, palmitic acid, lauric acid, isostearic acid, stearic acid, 12-hydroxystearic acid, 9,10-dihydroxystearic acid, oleic acid, 3,6-dioxaheptanoic acid, 3,6,9-trioxadecanoic acid, behenic acid, benzoic acid, p-tert.butylbenzoic acid, dimethyl hydroxybenzoic acid, 3,5-di-tert.butyl-4-hydroxybenzoic acid, toluic acid, dimethylbenzoic acid, ethylbenzoic acid, n-propylbenzoic acid, salicylic acid, p-tert.octyl salicylic acid and sorbic acid; zinc salts of dibasic carboxylic acids or monoesters thereof, such as oxalic acid, malonic acid, succinic acid, glutaric acid, adipic acid, fumaric acid, pentane-1,5-dicarboxylic acid, hexane-1,6-dicarboxylic acid, heptane-1,7-dicarboxylic acid, octane-1,8-dicarboxylic acid, 3,6,9-trioxodecane-1,10-dicarboxylic acid, lactic acid, malonic acid, maleic acid, tartaric acid, cinnamic acid, mandelic acid, malic acid, glycolic acid, oxalic acid, salicylic acid, polyglycol dicarboxylic acid (degree of oligomerization of the polyglycol preferably 10 to 12), phthalic acid, isophthalic acid, terephthalic acid and hydroxyphthalic acid; and the diesters or triesters of tri- or tetrabasic carboxylic acids, such as hemimellitic acid, trimellitic acid, pyromellitic acid, citric acid and so-called overbased zinc carboxylates.

The zinc enolates are preferably enolates of acetylacetone, benzoylacetone, dibenzoylmethane and enolates of acetoacetic and benzoylacetic esters and dehydroacetic acid. In addition, inorganic zinc compounds, such as zinc oxide, zinc hydroxide, zinc sulfide or zinc carbonate, may also be used.

Preferred zinc carboxylates are those of a C₇₋₂₅ carboxylic acid (zinc soaps) such as, for example, benzoates or alkanoates, preferably C₈ alkanoates, stearate, oleate, laurate, palmitate, behenate, versatate, hydroxystearates, dihydroxysearates, p-tert.butylbenzoate or (iso)octanoate. Stearate, oleate, versatate, benzoate, p-tert.butylbenzoate and 2-ethylhexanoate are particularly preferred.

Besides the zinc compounds mentioned, organic aluminium, cerium or lanthanum compounds with a metal-O-bond may also be used. Suitable and preferred aluminium compounds include carboxylates and enolates.

The compounds d28) are antistatic agents. As the expert is aware, antistatic agents (“antistatics”) are divided into external and internal antistatics. External antistatics are products which are applied as a thin layer to the surface of PVC moldings. The disadvantage of this surface coating lies in the poor durability of the antistatic effect so that the protective effect gradually diminishes and an aftertreatment has to be applied, above all after rinsing and washing. Internal antistatics are part of the PVC compound and are incorporated in the PVC together with other additives. The major advantage of internal antistatics is the permanence of their effect. Examples of suitable antistatics are quaternary ammonium salts, amine derivatives, such as ethoxylated amines, and special phosphoric acid esters, hygroscopic substances, such as glycerol, glycol and other polyols.

The present invention also relates to a process for stabilizing halogen-containing organic plastics, more especially PVC, against thermal and/or photochemical degradation, characterized in that one or more fluoroalkanesulfonic acids, more particularly in the form of their alkali metal salts, is/are added to the plastics. In a preferred embodiment, the components, i.e. the antistatically finished PVC and the fluoroalkanesulfonic acids, are thoroughly mixed in suitable units.

The stabilizer compositions according to the invention may advantageously be incorporated by the following methods:

as an emulsion or dispersion (for example in the form of a paste-form mixture, in which case an advantage of the combination according to the invention is the stability of the paste);

as a dry blend during the mixing of added components or polymer mixtures;

by direct introduction into the processing unit (for example calender, mixer, kneader, extruder and the like) or

as a solution or melt.

The present invention also relates to a PVC which contains one or more fluoroalkanesulfonic acids. A stabilized PVC such as this may be produced in known manner, for which purpose the fluoroalkanesulfonic acids or a stabilizer combination according to the invention and optionally other typical additives for plastics are mixed with PVC in units known per se, such as the processing units mentioned above.

The stabilized PVC preferably contains the fluoroalkanesulfonic acids in a quantity of 0.01 to 2.0 phr and more particularly 0.01 to 0.5 phr. The expression “parts per hundred resin” (phr) familiar to the expert indicates how many parts by weight of the component are present in the PVC, based on 100 parts by weight PVC.

The PVC stabilized in accordance with the invention may be brought into the required shape by known methods such as, for example, grinding, calendering, extrusion, injection molding, sintering or spinning, extrusion blowing or processing by the plastisol process.

Extrusion and injection molding are particularly preferred processes for processing the PVC stabilized in accordance with the invention.

The PVC stabilized in accordance with the invention is suitable for rigid, semirigid and flexible formulations.

Halogen-Containing Organic Plastics

The halogen-containing organic plastics to be stabilized with the fluoroalkanesulfonic acids or with the stabilizer compositions according to the invention are, in particular, chlorine-containing polymers or recyclates thereof. Examples of such chlorine-containing polymers or recyclates to be stabilized are polymers of vinyl chloride, vinyl resins containing vinyl chloride units in their structure, such as copolymers of vinyl chloride and vinyl esters of aliphatic acids, more particularly vinyl acetate, copolymers of vinyl chloride with esters of acrylic and methacrylic acid and with acrylonitrile, copolymers of vinyl chloride with diene compounds and unsaturated dicarboxylic acids or anhydrides thereof, such as copolymers of vinyl chloride with diethyl maleate, diethyl fumarate or maleic anhydride, post-chlorinated polymers and copolymers of vinyl chloride, copolymers of vinyl chloride and vinylidene chloride with unsaturated aldehydes, ketones and others, such as acrolein, crotonaldehyde, vinylmethyl ketone, vinylmethyl ether, vinylisobutyl ether and the like; polymers of vinylidene chloride and copolymers thereof with vinyl chloride and other polymerizable compounds; polymers of vinyl chloroacetate and dichlorodivinyl ether; chlorinated polymers of vinyl acetate, chlorinated polymeric esters of acrylic acid and α-substituted acrylic acid; polymers of chlorinated styrenes, for example dichlorostyrene; chlorinated polymers of ethylene; polymers and post-chlorinated polymers of chlorobutadiene and copolymers thereof with vinyl chloride; and mixtures of the polymers mentioned with one another or with other polymerizable compounds.

Graft polymers of PVC with EVA, ABS and MBS are also included. Other preferred substrates are mixtures of the above-mentioned homo- and copolymers, more particularly vinyl chloride homopolymers, with other thermoplastic and/or elastomeric polymers, more particularly blends with ABS, MBS, NBR, SAN, EVA, CPE, MBAS, PMA, PMMA, EPDM and polylactones.

Suspension and bulk polymers and emulsion polymers are also preferred.

The particularly preferred chlorine-containing polymer is polyvinyl chloride, more especially suspension polymer and bulk polymer.

In the context of the invention, PVC is also understood to include copolymers or graft polymers of PVC with polymerizable compounds, such as acrylonitrile, vinyl acetate or ABS, in the form of suspension, bulk or emulsion polymers. PVC homopolymer—even in combination with polyacrylates—is preferred.

Recyclates of chlorine-containing polymers are also suitable, recyclates being the polymers described in detail in the foregoing which have been damaged by processing, use or storage. PVC recyclate is particularly preferred. The recyclates may also contain small quantities of foreign materials such as, for example, paper, pigments, adhesives, which are often difficult to remove. These foreign materials may even emanate from contact with various substances during use or working up, including for example fuel residues, paint/lacquer, metal traces and initiator residues.

### EXAMPLES

Substances Used

Evipol SH 6030=S-PVC (k value=60)

Omyalithe 97 T=chalk

Zeolite A

Dipentaerythritol

Magnesium stearate

Trifluoromethanesulfonic acid, Na salt

Dimethyl aminouracil (corresponding to the formula in the description) as a commercially available product

N,N′-dimethyl-N-cyanoacetylurea=commercially available substance

### Examples 1 to 8

Table 1 below shows on the one hand the individual ingredients of the test formulations and, on the other hand, the test results obtained. The numbers of the Examples are shown in the first line of the Table. The quantities of the individual components are expressed in phr (phr=parts per hundred resin) which indicates how many parts by weight of the particular component are present in the PVC (based on 100 parts by weight PVC) after addition of the composition. Accordingly, the formulations each contain 100 parts PVC (Evipol SH 6030).

Examples 2 and 4 and 6 to 8 correspond to the invention. Examples 1, 3 and 5 are intended for comparison.

The test formulations were subjected—partly or completely—to the following measurements:

Stability test under heat stress. Strips were produced from the formulations and tested for static thermal stability at 170° C. The strips were produced by homogenizing and plasticizing the PVC powder mixture and the formulation components mentioned for 5 minutes at 170° C. on a laboratory roll mill. Test specimens measuring 17×17 mm were cut out from the ca. 0.5 mm thick strips thus produced. The test specimens were placed in a heating cabinet at 170° C. on glass plates on rotating trays and removed at 15-minute intervals until all the test specimens were “burnt” (i.e. were black in color).

Color measurement on strips. In addition, the L*,a*,b*-method (cf. DIN 6174) known to the expert was applied to the test strips used for further characterization. The L value indicates the lightness. A commercially available instrument (Dr. Lange “Micro Color”) was used for the measurements.

Congo Red stability test. In addition, the Congo Red test known to the expert (Euro Standard EN 60811-3-2:1995, para. 9) was applied to the test strips for further characterization. To this end, small samples (50±5 mg) were taken from the strips and heated to 200° C. (±0.5° C.) in the corresponding glass tubes in a metal block.

A strip of universal indicator paper was inserted into the upper end of the glass tube. The time taken by the color of the indicator paper to just change to red was measured in minutes.

TABLE 1

| | 1 | 2 | 3 | 4 | 5 | 6 | 7 | 8 |
|---|---|---|---|---|---|---|---|---|
| Formulations- | | | | | | | | |
| constituents in phr | | | | | | | | |
| Evipol SH 6030 | 100 | 100 | 100 | 100 | 100 | 100 | 100 | 100 |
| Omyalithe 95 T | 3 | 3 | 3 | 3 | 3 | 3 | 3 | 3 |
| Zeolite A | 0.84 | 0.84 | 0.84 | 0.84 | 0.84 | 0.84 | 0.84 | 0.84 |
| Magnesium stearate | 0.4 | 0.4 | 0.4 | 0.4 | 0.4 | 0.4 | 0.4 | 0.4 |
| Dipentaerythritol | 0.33 | 0.33 | — | — | — | — | — | — |
| Dimethylaminouracil | — | — | 0.3 | 0.3 | — | — | — | — |
| N.N′-Dimethyl-N-cyano- | — | — | — | — | 0.33 | 0.33 | 0.33 | 0.33 |
| acetylurea (*) | | | | | | | | |
| Trifluormethanesulfonic | — | 0.05 | — | 0.1 | — | 0.002 | 0.013 | 0.05 |
| acid, Na salt | | | | | | | | |
| Color measurement on | | | | | | | | |
| strips\[L] | | | | | | | | |
| Without storage | 67 | 79 | 80 | 78 | 80 | 80 | 80 | 80 |
| 15 mins. at T = 180° C. | 26 | 67 | 75 | 73 | 75 | 74 | 77 | 75 |
| 30 mins. at T = 180° C. | | 55 | 66 | 69 | 46 | 66 | 69 | 72 |
| End of stability after | | | | | | | | |
| storage in an oven | | | | | | | | |
| (T = 180° C.) | | | | | | | | |
| [mins.] | 15 | 75 | 45 | 60 | 45 | 60 | 60 | 90 |
| Congo Red end | | | | | | | | |
| of stability | | | | | | | | |
| (T = 200° C.) | | | | | | | | |
| [mins.] | 13 | 17 | 9 | 14 | 12 | 14 | 17 | 19 |

1-8. (Canceled).

9. A method of stabilizing a halogen-containing organic plastic, said method comprising:
(a) providing a fluoroalkanesulfonic acid; and
(b) combining the fluoroalkanesulfonic acid and the halogen-containing organic plastic.

10. The method according to claim 9, wherein the fluoroalkane sulfonic acid has a single sulfonic acid group per molecule.

11. The method according to claim 9, wherein the fluoroalkane sulfonic acid comprises a completely fluorinated alkanesulfonic acid having from 1 to 18 carbon atoms.

12. The method according to claim 10, wherein the fluoroalkane sulfonic acid comprises a completely fluorinated alkanesulfonic acid having from 1 to 18 carbon atoms.

13. The method according to claim 9, wherein the fluoroalkane sulfonic acid comprises a salt of a fluoroalkanesulfonic acid.

14. The method according to claim 10, wherein the fluoroalkane sulfonic acid comprises a salt of a fluoroalkanesulfonic acid.

15. The method according to claim 12, wherein the fluoroalkane sulfonic acid comprises a salt of a fluoroalkanesulfonic acid.

16. The method according to claim 9, wherein the fluoroalkanesulfonic acid comprises trifluoromethanesulfonic acid.

17. The method according to claim 13, wherein the salt comprises a salt of trifluoromethanesulfonic acid.

18. The method according to claim 17, wherein the salt is selected from the group consisting of lithium, sodium and potassium salts of trifluoromethanesulfonic acid.

19. The method according to claim 9, wherein the fluorosulfonic acid is combined with the halogen-containing organic plastic in a quantity of from 0.001 to 2 phr.

20. A stabilizer composition comprising a fluoroalkanesulfonic acid and one or more plastic additives.

21. The stabilizer composition according to claim 20, wherein the fluoroalkane sulfonic acid has a single sulfonic acid group per molecule.

22. The stabilizer composition according to claim 20, wherein the fluoroalkane sulfonic acid comprises a completely fluorinated alkanesulfonic acid having from 1 to 18 carbon atoms.

23. The stabilizer composition according to claim 21, wherein the fluoroalkane sulfonic acid comprises a completely fluorinated alkanesulfonic acid having from 1 to 18 carbon atoms.

24. The stabilizer composition according to claim 20, wherein the fluoroalkane sulfonic acid comprises a salt of a fluoroalkanesulfonic acid.

25. The stabilizer composition according to claim 20, wherein the fluoroalkanesulfonic acid comprises trifluoromethanesulfonic acid.

26. The stabilizer composition according to claim 24, wherein the salt comprises a salt of trifluoromethanesulfonic acid.

27. The stabilizer composition according to claim 26, wherein the salt is selected from the group consisting of lithium, sodium and potassium salts of trifluoromethanesulfonic acid.

28. A polyvinylchloride formulation comprising a fluoroalkanesulfonic acid and a chlorine-containing polymer.
